(19) United States
(12) Patent Application Publication
(10) Pub. No.: US 2003/0140008 A1
(43) Pub. Date: Jul. 24, 2003

(54) Image processing system and image processing service method

(76) Inventor: Hirokazu Kawamoto, Tokyo (JP)

Correspondence Address: FITZPATRICK CELLA HARPER & SCINTO, 30 ROCKEFELLER PLAZA, NEW YORK, NY, 10112, US

(21) Appl. No.: 10/338,851

(22) Filed: Jan. 9, 2003

(30) Foreign Application Priority Data
Jan. 23, 2002 (JP) 2002-014636

(51) Int. Cl. G06F 17/60

(52) U.S. Cl. 705/40

(57) ABSTRACT

In an image processing system in which an image input apparatus, an image processing apparatus and an image output apparatus are connected via a public network, an image processing method and apparatus in which the image input apparatus generates image data for output by extracting electronic watermark data embedded in the digital contents of the image and generating account information based on the electronic watermark data (S301) , and transmits the image data and the account information to the image processing apparatus (S304). In response to an output request from the image output apparatus (S306), the image processing apparatus bills for the image data output based on the account information (S307) and also transmits the image data to the image output apparatus (S308), so as to execute printing at the image output apparatus (S309).

### FIELD OF THE INVENTION

The present invention relates to an image processing system that prints information including digital contents for a fee, and an image processing service method using the image processing system.

### BACKGROUND OF THE INVENTION

A printer is the most common type of apparatus for outputting information including digital contents. For ease of explanation, a description is first given of the printer driver that is the data output control apparatus for controlling the output of the printer. It should be noted that the term “digital contents” appearing in the following description means moving images, still images, audio, computer programs, computer data, and so forth, and the term “data (or information) including digital contents” means digital contents together with text data, graphics data and the like.

In general, a computer to which a printer is connected is loaded with a printer driver for controlling the printer. When printing, the computer supplies image data that is created with an application loaded into the computer and that includes text, drawings, natural images and the like to the printer driver as print information. The printer driver generates print data that can be printed by the printer based on the print information so supplied and transmits that print data to the printer.

Known methods of creating print data in a printer driver are described below.

There is a method in which print data is created by first analyzing the print information transferred from the application and digitizing the image data included in the print information using a predetermined technique, and rasterizing that digitized data to a band memory.

Another method of creating print data involves analyzing the print information transferred from the application, rasterizing the image data included in the print information to a band memory as multivalic data, and creating print data while digitizing the rasterized data in raster line units using a predetermined technique.

Yet another method analyzes the print data transferred from the application and generates printer control language (so-called PDL, or Page Description Language) that the printer understands.

Either dithered pattern or error diffusion may be used to achieve the above-described digitization. Using a dithered pattern makes for high speed and uniform digitization, and so is suitable for digitizing text and figures. By contrast, the error diffusion method can express subtle differences in tone and so is suitable for digitizing natural images.

Next, a description of electronic watermarking is given in order to facilitate an understanding of the state of the art and hence of the present invention. The advantage of digital data compared to conventional analog data is that digital data can be copied and interpolated easily by computer without any degradation, and moreover, digital data can be easily forwarded via telecommunications lines. However, these same advantages make digital data vulnerable to unauthorized copying and distribution.

One method of preventing such unauthorized copying and distribution is to embed an electronic watermark in the digital data. An electronic watermark cannot be detected by the naked eye, and cannot be detected when reproducing by ordinary methods digital contents in which an electronic watermark is embedded.

One method of embedding an electronic watermark, for example for a digital image, involves manipulating the data values of the digital contents that correspond to the hue and brightness of the picture elements (pixels) and embedding an electronic watermark. The most common example involves dividing the digital contents into blocks and adding a predetermined watermark pattern through a combination of +1 or −1 for each block, as disclosed for example in U.S. Pat. No. 5,636,292 to Digimarc Corporation.

Another method of embedding an electronic watermark involves performing a frequency transform such as a fast Fourier transform, discrete cosine transform (DCT) or wavelet transform on the digital contents and adding watermark data to the frequency domain, after which an inverse frequency transform is performed so as to embed the electronic watermark.

A more detailed description of the fast Fourier transform embedding method described above is now given. According to such a method, a PN series is first added to the input contents and the contents dispersed, after which the contents are divided into blocks. A Fourier transform is then performed on each block to imbed 1 bit of watermark data in 1 block. An inverse Fourier transform is then performed on the block in which the watermark data is imbedded and the same PN series as at the beginning is once again added so as to obtain contents in which an electronic watermark is embedded. This method is described in detail in Ohnishi, Oka and Matsui, “Signature Methods for Images Using a PN Series”.

A more detailed description of the discrete cosine transform embedding method described above is now given. First, the input contents are divided into blocks and a discrete cosine transform is performed on each block. Then, 1 bit of data is embedded in 1 block, after which an inverse transformation is performed, generating contents with an embedded electronic watermark. This method is described in detail in Nakamura, Ogawa and Takashima, “Electronic Watermarking in Frequency Domain for Digital Image Copyright Protection” (1997, Coding and Data Security Symposium, Lectures and Collected Papers, SCIS' 97-27A).

According to the wavelet transform embedding method described above, there is no need to divide the input contents into blocks. This method is described in detail in Ishizuka, Sakai and Sakurai, “Experimental Considerations Concerning the Safety and Reliability of Electronic Watermarking Using Wavelet Transforms” (1997, Coding and Data Security Symposium, Lectures and Collected Papers, SCIS' 97-26D).

Although the methods described above make it possible to embed an electronic watermark in digital contents, the type of information that electronic watermarks embedded by these methods provide is usually limited to copyright data or user data. By embedding copyright data in digital contents as an electronic watermark, the user can install a copyright in the digital contents and the owner of the copyright can be identified thereby. By embedding user data, it becomes possible to provide a variety of user services using that data.

A public print system for providing digital contents print service is known conventionally. However, the conventional public print system or public print service does not make full use of the information embedded as an electronic watermark in digital contents.

### SUMMARY OF THE INVENTION

Accordingly, the present invention is proposed to solve the above-described problem of the conventional art, and has as its object to provide an easier-to-use image processing system or image processing service by utilizing the electronic watermark data embedded in digital contents when outputting for a fee image data input from an image input apparatus at an image output apparatus.

The above-described object of the present invention is achieved by an image processing system comprising an image input apparatus, an image processing apparatus and an image output apparatus, in which the image input apparatus, the image processing apparatus and the image output apparatus are connected via a public network and the image processing system generates account information at the image processing apparatus when outputting data input from the image input apparatus using the image output apparatus. The image input apparatus generates image data for output based on information including digital contents, extracts electronic watermark data embedded as an electronic watermark in the digital contents and generates account information based on the electronic watermark data, and transmits the image data and the account information to the image processing apparatus. The image processing apparatus bills based on the account information in response to an output request from the image output apparatus and transmits the image data to the image output apparatus. The image output apparatus outputs the image data transmitted from the image processing apparatus.

In addition, the above-described object of the present invention is also achieved by an image processing system comprising an image input apparatus and an image output apparatus, in which the image input apparatus and the image output apparatus are connected via a public network, and the image processing system generates account information when outputting from the image output apparatus image data input from the image input apparatus. The image input apparatus generates image data for output based on information including digital contents, extracts electronic watermark data embedded as an electronic watermark in the digital contents and generates account information based on the electronic watermark data, and transmits the image data and the account information to the image processing apparatus. The image processing apparatus bills based on the account information in response to an output request from the image output apparatus and outputs the image data.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention, in which:

FIG. 1 is a block diagram of a public print system according to one embodiment of the present invention;

FIG. 2 is a block diagram of a computer terminal;

FIG. 3 is a flow chart of steps in a full printing process;

FIG. 4 is a flow chart of steps in a process of generating a print job;

FIG. 5 is a diagram showing an example of a user interface for selecting a printer driver of the present embodiment;

FIG. 6 is a diagram showing an example of data including digital contents;

FIG. 7 is a diagram showing an example of electronic watermark attribute data;

FIG. 8 is a diagram showing the structure of a print job;

FIG. 9 is a diagram showing the attributes of a print job;

FIG. 10 is a diagram showing a fee schedule for use in calculating account information;

FIG. 11 is a diagram showing printing fee discount rates for each type of electronic watermark;

FIG. 12 is a diagram showing an example of a user interface used in confirming transmission of a print job;

FIG. 13 is a block diagram showing a public print system according to a variation of the present embodiment;

FIG. 14 is a diagram showing an example of a setting of a upper limit discount rate as a variation of the present embodiment; and

FIG. 15 is a diagram showing an example of print job attributes in a variation of the present embodiment.

### DETAILED DESCRIPTION OF THE PREFERRED EMBODIMENTS

Preferred embodiments of the present invention will be described in detail in accordance with the accompanying drawings.

The System Configuration.

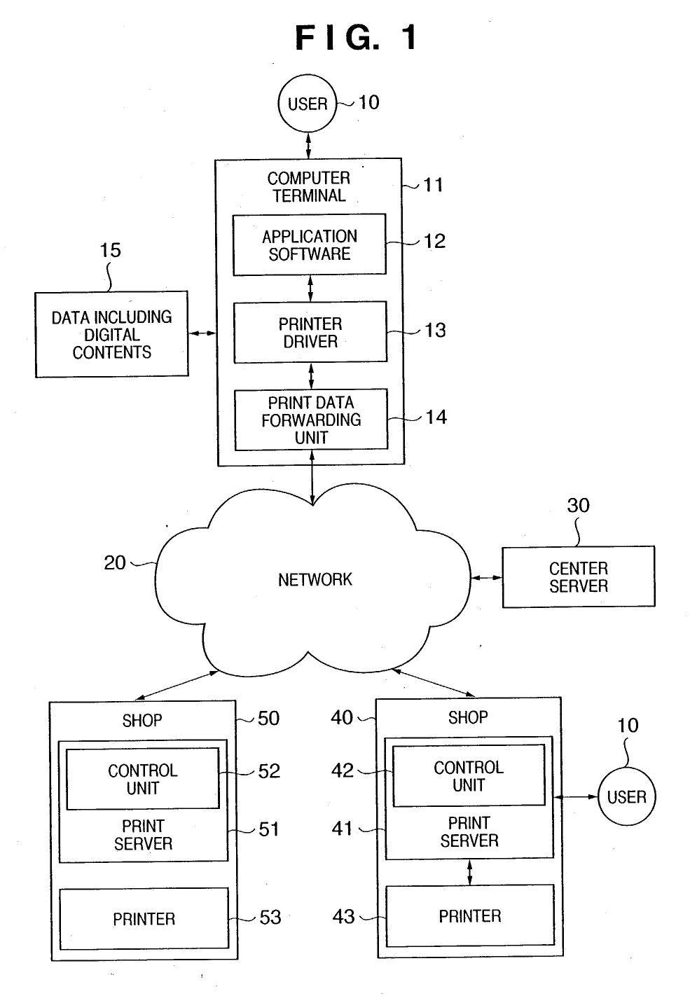

FIG. 1 is a block diagram of a public print system according to one embodiment of the present invention. The diagram shows a case in which the system has a printer control apparatus (printer driver) for a data output control apparatus, a center server that acquires print data transmitted via the Internet from the data output control unit and both transmits the print data to a print server to be described later and bills account information for doing so, a print server that acquires print data transmitted from the center server, and a printer.

The printing system of the present embodiment forms a public print system that prints data including digital contents for a fee. A detailed description of specific compositional elements of the system depicted in FIG. 1 is provided below.

In the diagram, reference numeral 10 denotes a customer who orders a printing (hereinafter referred to as a user), reference numeral 11 denotes a computer terminal for facilitating the ordering of a printing, reference numeral 20 denotes a network formed by a public network such as the Internet, reference numeral 30 denotes a center server, and reference numerals 40 and 50 denote shops that perform the actual printing in response to an order.

The user's computer terminal 11 comprises an application denoted by reference numeral 12, a printer driver denoted by reference numeral 13, and a print data forwarding unit denoted by reference numeral 14 for forwarding to the center server the print data generated by the printer driver 13. Reference numeral 15 denotes data including digital contents that the user 10 orders for printing.

The shop 40 comprises a print server denoted by reference numeral 41 that controls the printing of data including digital contents ordered by the user 10 for printing, reference numeral 42 denotes a control unit for operating the print server 41, and reference numeral 43 denotes a printer for actually printing the digital contents. It should be noted that both shops 40 and 50 have the same composition, and it is possible that a plurality of shops exist as is the case here.

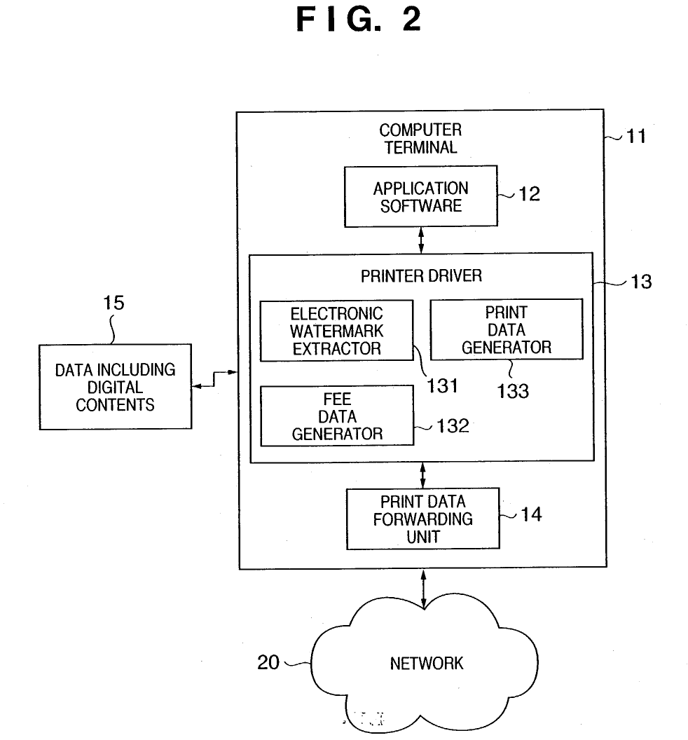

FIG. 2 is a detailed block diagram of the computer terminal 11. The computer terminal 11 has application software 12 having the capability to read data including digital contents like that denoted by reference numeral 15 from an external source and to process that data, and a printer driver 13 that converts image data generated by the application software 12 into print commands.

The printer driver 13 has an electronic watermark extraction unit 131 for extracting an electronic watermark embedded in digital contents, a fee data generator 132 that analyzes the embedded data from which the image data has been extracted by the electronic watermark extraction unit 131 and generates account information including discount data, and print data generator 133 that generates the actual print data. The account information and print data thus generated are then sent to the print data forwarding unit 14 and forwarded to the center server 30 via the network 20.

Steps in the Printing Process

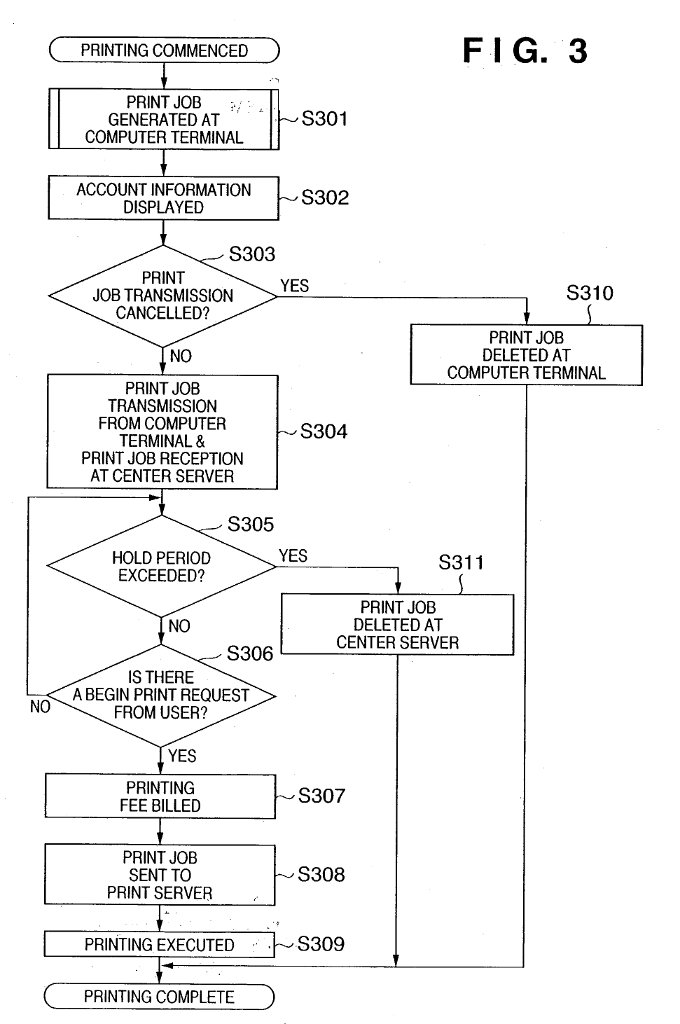

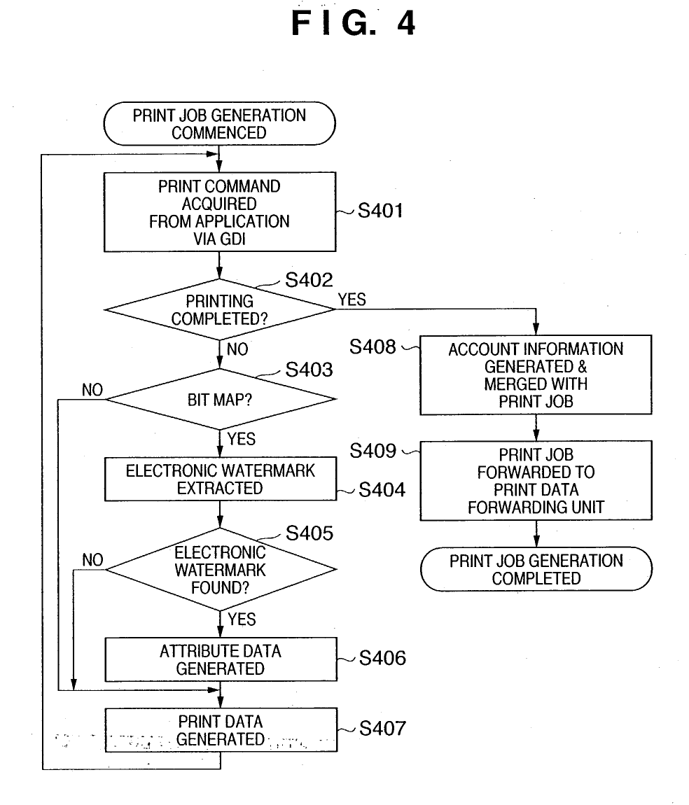

A detailed description is given below of the printing process of the present embodiment, using the flow charts depicted in FIGS. 3 and 4.

FIG. 3 is a flow chart showing steps in a full printing process, from start of printing to finish. FIG. 4 is a flow chart showing steps in a process of generating a print job.

First, the user 10 starts the application software 12 that runs on the computer terminal 11, reads the data including digital contents via the network from the web server onto a recording medium that is installed in the computer terminal 11 such as either a floppy disk, a hard disk, a CD-ROM or a DVD, and performs a dialog process for the purpose of data processing and editing as well as print ordering.

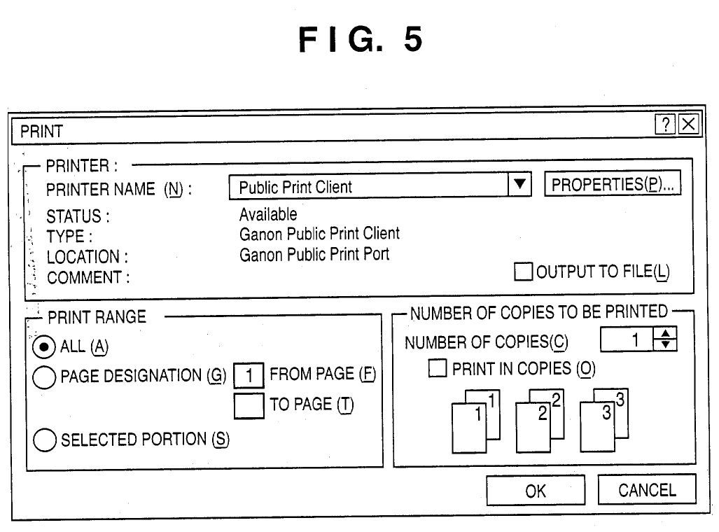

FIG. 5 is a diagram showing an example of a user interface for selecting a printer driver of the present embodiment. A user's print order originates with the selection of “Public Print Client” in the print dialog box shown in FIG. 5 and then clicking on the “OK” button, which generates a print job in a step S301. It should be noted that the dialog box shown in FIG. 5 is opened by the user 10 pressing the “Properties(P)” button prior to pressing the “OK” button in the dialog box shown in FIG. 5, and in the user interface (not shown in the diagram) that displays the printer driver 13, user data (customer ID, credit card information, and the like) can be input.

Generating a Print Job

A detailed description is given below of the process of generating a print job as shown in step S301 of FIG. 3, with reference to FIGS. 4, 5 and 6.

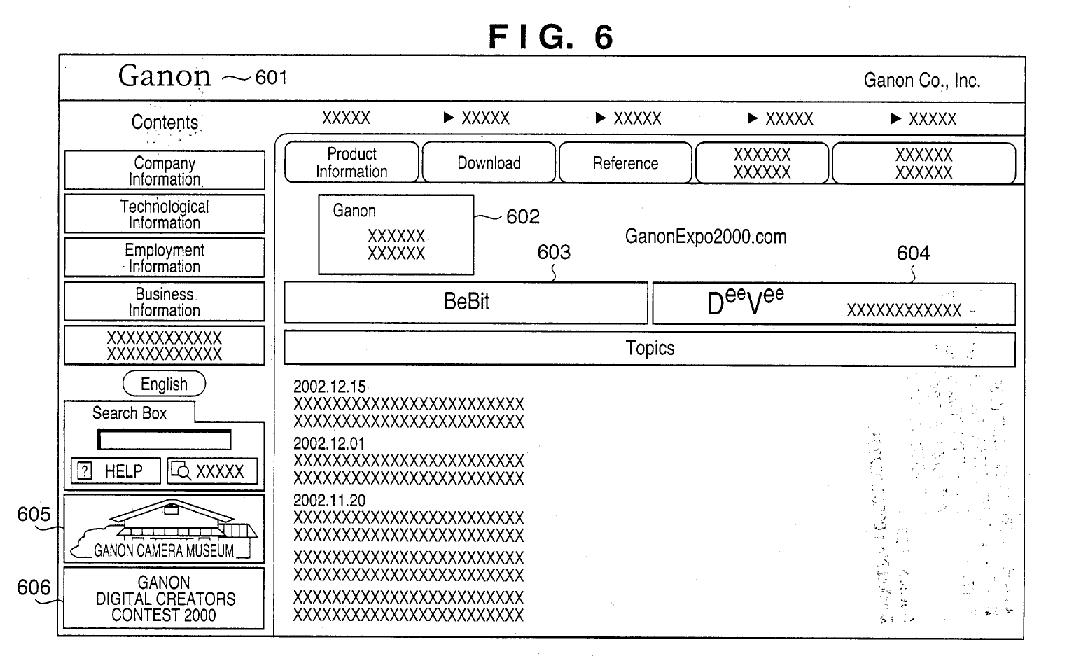

FIG. 6 is a diagram showing an example of data including digital contents.

When the printing process is commenced by pressing the “OK” button in the print dialog box depicted in FIG. 5, the application software 12, based on the data including digital contents, sequentially performs printing until printing is completed via the printing API that the OS provides. The printer driver 13 receives a print request from the application software 12 via the print API that the OS provides and proceeds with processing.

The printer driver 13 first, in a step S401, acquires a print command from the application software 12 via a Graphics Device Interface (hereinafter GDI).

Next, in a step S402, it is determined whether or not the acquired print command is a print complete command. If the acquired print command is not a print complete command, then in a step S403 it is determined whether or not the received command is a bit map draw command. The determination as to whether or not the command in question is a bit map draw command or not can be made by determining whether or not the acquired print command is a command that relates to bit map drawing. Specifically, the determination is made by whether or not the BitBlt, SetDIBitsToDevice, StretchBlt, StretchDIBtis and other bit map processing I/F that the printer driver 13 prepares for the GDI has been called. For example, where data including digital contents 15 like that shown in FIG. 6 is ordered for printing, the parts 601-606 that are circled in the diagram indicate digital contents that are extracted by the electronic watermark extractor 131, which are printed by the bit map processing I/F.

If the results of the determination made in step S403 indicate that the print command is not a bit map draw command, then the print data corresponding to the received command is generated by the print data generator 133 mounted inside the printer driver 13 in a step S407 and the process returns to step S401.

On the other hand, if the results of the determination made in step S403 indicate that the print command is a bit map draw command, then in a step S404 an attempt is made by the electronic watermark extraction unit 131 mounted inside the printer driver 13 to extract the electronic watermark for the bit map acquired via the GDI. In a step S405 it is determined whether or not the electronic watermark has been extracted, and if not, the print data generator 133 generates print data in step S407 and the process returns to step S401. If the electronic watermark has been extracted, then the process proceeds to a step S406, where electronic watermark attribute data is generated.

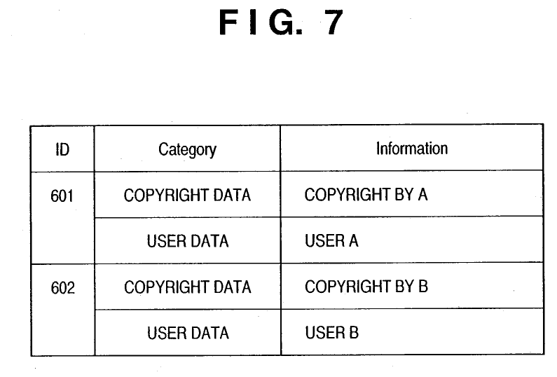

FIG. 7 is a diagram showing an example of electronic watermark attribute data. As shown in the diagram, the electronic watermark detected in the present embodiment is divided into two broad categories: copyright data and user data. The “ID” shown in FIG. 7 corresponds to reference numerals 601, 602 of the 6-bit map depicted in FIG. 6, that is, indicates that electronic watermark data is included in the bit maps 601, 602. Specifically, in bit map 601, the copyright data reads “Copyright by A” and the user data reads “User A”; in bit map 602, the copyright data reads “Copyright by B” and the user data reads “User B”.

The generation of the attribute data in step S406 is carried out in sequence for the bit map undergoing processing, and each time an electronic watermark is detected during printing, attribute data is added. It should be noted that the “ID” in FIG. 7 is an item associated with FIG. 6 for ease of explanation of the present embodiment, and is not required as actual attribute data.

When step S406 is complete, the print data generator 133 generates the actual print data (in a step S407) in the same manner as when no electronic watermark is detected and the process returns to step S401. Thus, by repeatedly generating print data, detecting an electronic watermark and generating attribute data, a print job is generated until a print termination command is acquired in step S402.

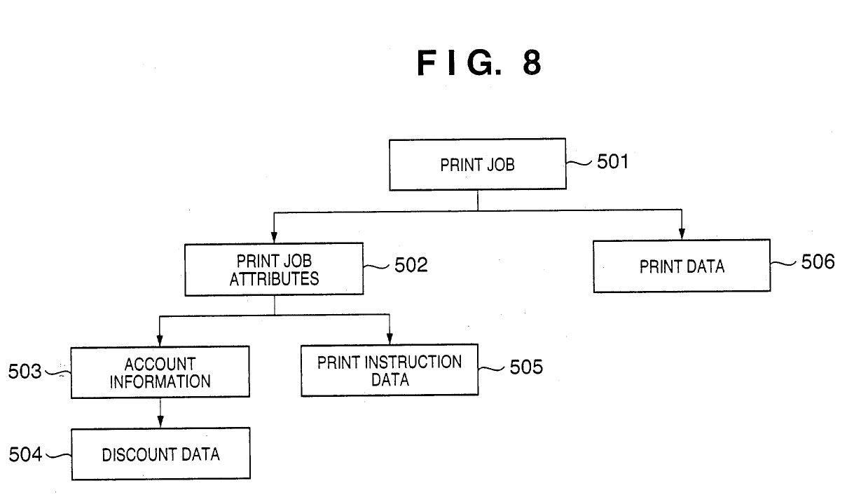

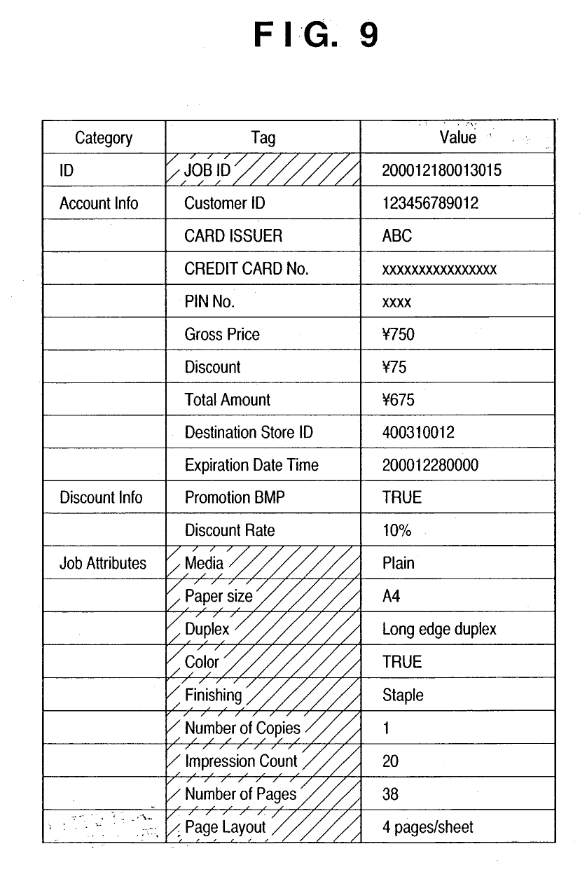

A description is now given of the structure of a print job generated by the printer driver 13 of the present embodiment, with reference to FIG. 8 and FIG. 9.

FIG. 8 is a diagram showing the structure of a print job. As shown in the diagram, besides actual print data 506, a print job 501 is also composed of print job attributes 502 that include account information 503, discount data 504 and print instruction data 505. It should be noted that, with respect to the print job generation depicted in FIG. 4, although no detailed description of the generation of the print job attributes 502 and the print instruction data 505 is given, nevertheless this data is generated at an appropriate timing.

FIG. 9 is a diagram showing the print job attributes. Half-tone dot meshing, or hatching, is attached in the TAG column to the data generated during printing of the print data depicted in FIG. 9. For example, the JOB ID used to identify the print job until printing is completed, as well as the “Paper Size”, “Duplex”, “Finishing”, “Number of Copies”, “Impression Count”, “Number of Pages” and “Page Layout” are generated during printing.

To return to the description of FIG. 4, when it is determined during printing in step S402 that there is a print complete command, the printer driver 13 generates account information in a step S408. In other words, account information 503 and discount data 504 are generated based on print instruction data 505 already generated.

The “Account info” category of FIG. 9 corresponds to account information 503, the details of which, such as “Customer ID”, “Card Issuer”, “Credit Card No.” and “PIN No.”, as well as “Destination Store ID”, are input by the user 10 via a user interface (not shown in the diagram) provided by the printer driver 13 and stored as is as “Print Destination Store Information” in an external memory device (not shown in the diagram) provided with the computer terminal 11. In a step S408, this data is read out from the external memory device and account information 503 is generated. All account information 503 other than the “Print Destination Store Information” is kept encrypted.

It should be noted that, in the “Account Info” depicted in FIG. 9, an “Expiration Date Time” is automatically generated, for example, as 0:00 ten days after a request to print has been made. FIG. 9 shows a case in which the date of print request is Dec. 18, 2000, so the print job expiration date is Dec. 28, 2000, at 0:00.

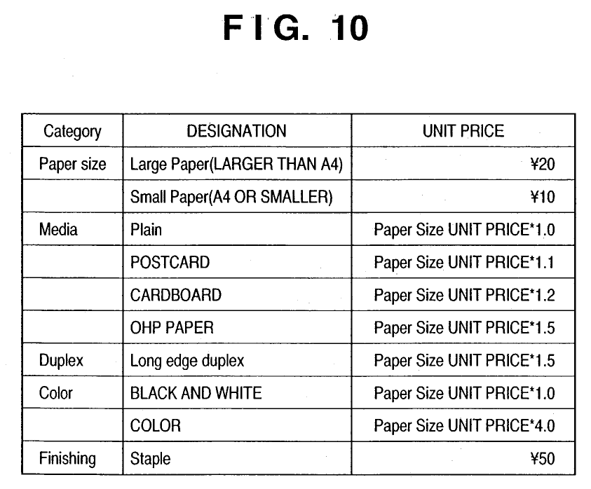

The other account information depicted in FIG. 9, such as “Gross Price”, “Discount” and “Total Amount”, is calculated and set according to the steps described below, with reference to FIG. 10.

FIG. 10 is a diagram showing a fee schedule for use in calculating account information.

First, the “Gross Price” is calculated according to the fee schedule depicted in FIG. 10 and to the setting values for the print instruction data 505 (Job Attributes) “Media”, “Paper Size”, “Duplex”, “Color”, “Finishing”, “Number of Copies” and “Impression Count”. A concrete example of such a calculation is given below:

$$Gross Price = \{ Paper Size * ( Media + Duplex + Color ) * Impression Count / 2 + Finishing \} * Number of Copies = \{ 10 * ( 1.0 + 1.5 + 4.0 ) * 20 / 2 + 50 \} * \} = ¥750$$

It should be noted that the fee schedule data depicted in FIG. 10 is built into the printer driver 13, and can be changed by connecting the computer terminal 11 to the center server 30 when commencing printing or at some other, arbitrary time.

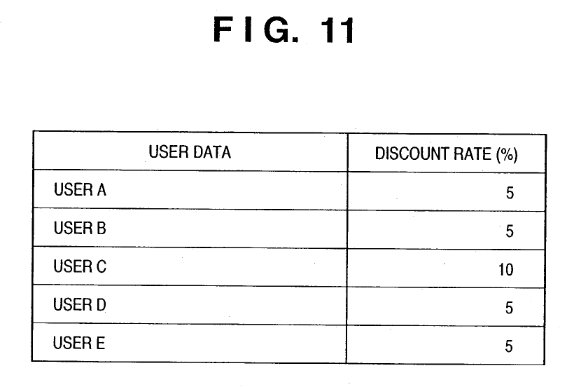

The “Discount” is calculated using the electronic watermark attributes shown in FIG. 7 and the printing fee discount rates shown in FIG. 11. FIG. 11 is a diagram showing printing fee discount rates for each type of electronic watermark (user data). It should be noted that the discount rate data shown in FIG. 11 is also stored in the printer driver 13, and any user data can be added to or deleted, and the discount rate changed, by connecting the computer terminal 11 to the center server 30 via the network 20, when commencing printing or at some other, arbitrary timing.

The discount application rule of the present embodiment is that the corresponding “Discount (%)” of FIG. 11 is applied whenever the “User Data” in the electronic watermark attribute data shown in FIG. 7 matches any of the “User Data” in the print fee discount schedule shown in FIG. 11. It should be noted that, in case there is a plurality of electronic watermarks in the print job, that plurality of attributes might match the “User Data” shown in FIG. 11, in which case the total discount applied is the sum of all the applicable individual discounts.

For example, in printing the data depicted in FIG. 6, two electronic watermark attributes 601, 602 are generated as shown in FIG. 7. By comparing the user data “User A” and “User B” in these two attributes to the “User Data” shown in FIG. 11, it can be seen that matches for each exist and discounts of 5% for User A and 5% for User B can be identified. In this case, the “Discount” is calculated as follows:

$$Discount = Gross price * ( 0.05 + 0.05 ) = 750 * 0.10 = ¥75$$

The “Total Amount” is based on the “Gross Price” and the “Discount” as calculated above, and is calculated as follows:

$$Total Amount = Gross price - Discount = 750 \cdot 75 = ¥675$$

It should be noted that the “Discount Info” category shown in FIG. 9 corresponds to the discount data 504, and in the above-described example the “Discount Rate” is 10%.

In a step S408, when production of the account information 503 and discount data 504 by the above-described processes is completed, according to the print job depicted in FIG. 8, this information and data is inserted into the print job 501. Then, the print job 501 so produced is forwarded to the print data forwarding unit 14 in a step S409.

Print Job Forwarding

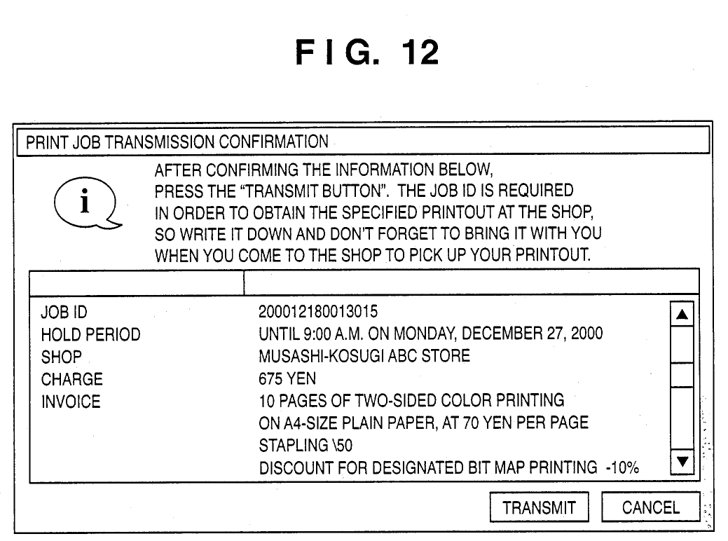

As described above with respect to FIG. 4, when print job generation at the computer terminal 11 in step S301 depicted in FIG. 3 is completed, the process then proceeds to a step S302. In the present embodiment, before sending the print job 501 to the center server 30, a dialog box is displayed on a CRT or other display device connected to the computer terminal 11 in order to obtain confirmation from the user 10. The dialog box displays account information. FIG. 12 is a diagram showing an example of a user interface used in confirming transmission of a print job. The dialog box shown in FIG. 12 has two buttons, “Transmit” and “Cancel”. The user 10 selects one of the two buttons and clicks thereon to select the next processing step.

Next, in a succeeding step S303, a determination is made as to which of the two buttons in the dialog box described above has been selected. If the “Cancel” button has been selected, the print process is cancelled and (in a step S310) the print job 501 created at the computer terminal 11 is deleted and printing terminates. On the other hand, if “Transmit” has been selected, the print data forwarding unit 14 forwards the print job 501 to the center server 30 via the network 20, which the center server 30 receives in a step S304.

Print Output

The center server 30, when it receives the print job 501, holds the received print job 501 until either a print request instruction is received from the control unit 42 that operates the print server 41 installed at the shop 40, or a hold period passes without receipt of a print request (that is, the Expiration Date Time accrues). A discrimination process is repeated until one of the following two conditions are matched: Either the hold period has passed (step S305) or a print request instruction is received from the user 10 control unit 42 (step S306). If the holding period passes and time expires, the print job 501 held in the center server 30 is deleted (S311) and printing terminates.

If in step S306 a print request is received from the user 10, the center server 30 figures the amount of the fee to be charged for printing based on the account information depicted in FIG. 9. In the example shown in FIG. 9, credit card company (that is, the Card Issuer) “ABC” is provided with the user's Credit Card No. xxxxxxxxxxxxxxxx and Pin No. xxxx, and is billed for ¥675 in a step S307. The billing transaction is instantaneously sent via the network 20 to the credit card company's transaction server (not shown in the diagram). Next, in a step S308, the print job 501 stored in the center server 30 is forwarded to the printer server 41 installed in the shop 40. The printer server 41 then transmits the print data 506 in the print job 501 thus received and executes printing.

Thus, as described above, according to the present embodiment, after the user 10 generates a print request at the computer terminal 11 in steps S301 through S304, the requested printing can be received from the printer 43 (in steps S307 through S309) by inputting in step S306 “200012120013015” as the “Job IMAGE DATA” shown in FIG. 9 at the control unit 42 of the printer server 41 installed at the shop 40 specified by the user 10.

As described above, according to the public print system of the present embodiment it is possible to generate discount data based on an electronic watermark embedded in digital contents by application software and to determine a printing fee discount using the discount data. Accordingly, it is possible to provide the user with a user-friendly public print system.

Variations

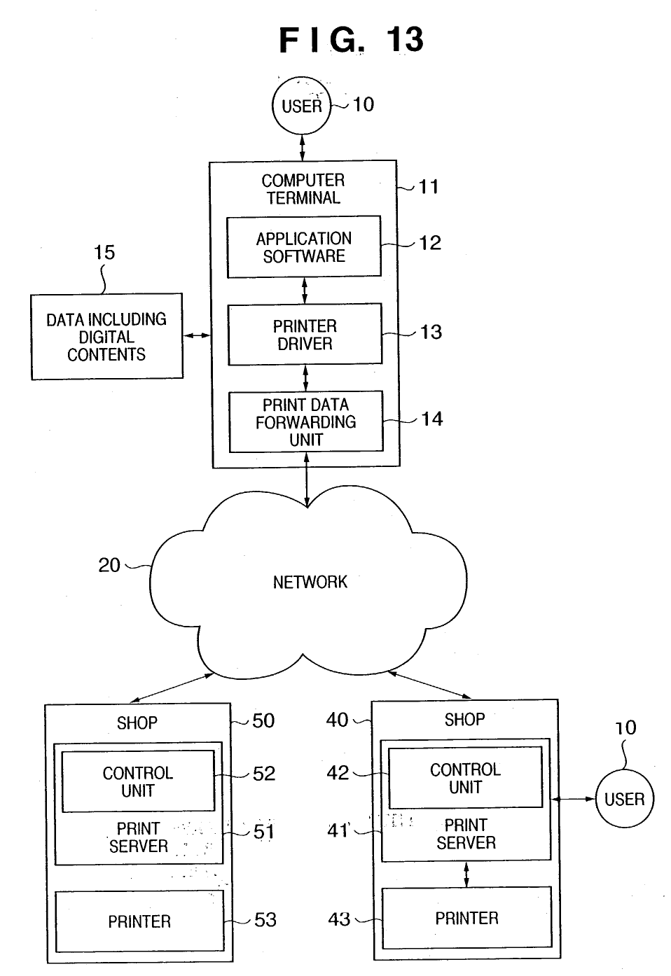

A description is now given of variations of the above-described embodiments, with reference to FIGS. 13, 14 and 15.

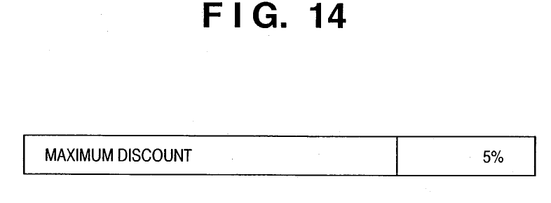

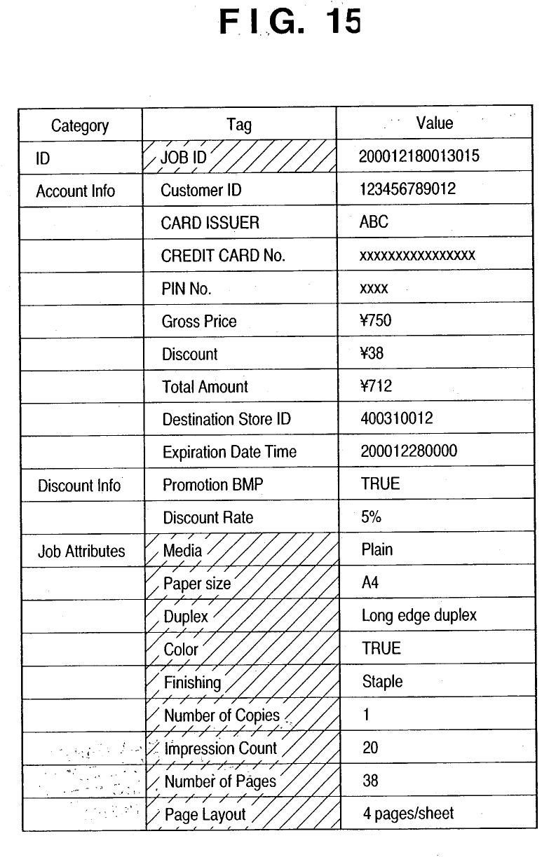

FIG. 13 is a block diagram showing a public print system according to a variation of the present embodiment. FIG. 14 is a diagram showing an example of a setting of a upper limit discount rate as a variation of the present embodiment. FIG. 15 is a diagram showing an example of print job attributes in a variation of the present embodiment.

It is possible to achieve the public print system according to the present invention by eliminating the center server 30 from the configuration shown in FIG. 1. For example, as shown in FIG. 3, the center server may be eliminated from the system and the functions of the center server 30 as described in the foregoing embodiments may be provided at the print server 41 in the shop 40 so that the print job is transmitted directly to the shop 40 from the computer terminal 11 via the network 20. According to such a structure, the print job is transmitted directly to the shop 40, so when the user issues a print instruction from the control unit 42 of the shop 40, there is no need for the shop 40 print server 41 to receive the print job from the center server 30, so the length of time to receipt of the printout can be shortened.

In addition, the process of calculating a discount based on a maximum discount as shown in FIG. 14 may be added to the account information generation and print job merge processes of step S408 of FIG. 4. In other words, there are two bit maps for which there are discounts in the above-described embodiments, each of 5%, for a total discount of 10%, which is set in the “Discount Rate” column of the table shown in FIG. 9. However, where the maximum discount is set at 5% as shown in FIG. 14, 5% is set in the “Discount Rate” column of the table shown in FIG. 15. Therefore, in such a case, since the account information is limited to a 5% discount rate, the sums shown for the “Gross Price”, “Discount” and “Total Amount” in FIG. 15 are also different from their equivalents in the example depicted in FIG. 9. It should be noted that although the data indicating the discount rate in FIG. 11 for “User C” is shown as 10%, since the maximum discount is set at 5% the printing fee is subjected to only a 5% discount even when bit maps are included that have electronic watermark user data corresponding to User C in the data that the user uses to make a print request.

By setting the maximum discount rate as described above, it is possible to avoid overly low printing charges due to excessive discounting even when there is a request to print data that includes a plurality of bit maps having electronic watermarks for which there are discounts.

It should be noted that the foregoing embodiments assume that the electronic watermark is embedded using techniques similar to the conventional methods. However, it is not necessary for the attribute data of the image expressed as an electronic watermark to be embedded in the image data. Rather, it is sufficient merely that the electronic watermark be invisible to the user. For example, image data may be processed as attribute-added image data to which attribute data has been added to the image data.

Other Variations

It should be noted that the present invention is equally applicable to a system comprising a plurality of components (such as a host computer, interface, reader, printer, and so on) as well as to a system comprising but a single component (such as a three-dimensional image printer or the like).

In addition, as can be appreciated by those of skill in the art, the object of the present invention may also be achieved by a software program code for achieving the functions of the foregoing embodiments being recorded onto a storage medium (or recording medium) that is supplied to a system or an apparatus, with a computer of that system or apparatus then reading the program code stored on the recording medium. In such a case, the program code read from the recording medium itself achieves the functions of the above-described embodiments, and the recording medium on which that program code is recorded constitutes the present invention. In addition, the present invention includes also an instance in which the execution of the program code read by the computer not only results in the achievement of the functions of the above-described embodiments but also the operating system (OS) operating in the computer performs part or all of the actual processing based on the instructions of the program code, with the functions of the above-described embodiments being achieved based on that processing.

Moreover, as can be appreciated by those of skill in the art, the present invention also includes an instance in which the functions of the above-described embodiments are achieved by processes executed in whole or in part by a CPU or the like provided in a function expansion card or a function expansion unit based on program code instructions, after the program code read from the recording medium is written to a memory provided in such a function expansion card inserted into the computer or such a function expansion unit connected to the computer.

According to the present invention as described above, by making more effective use of electronic watermark data including digital contents when outputting, for a fee, image data input from an image input apparatus at an image output apparatus, it is possible to provide a more user-friendly image processing system and image processing service.

The present invention is not limited to the above embodiments and various changes and modifications can be made within the spirit and scope of the present invention. Therefore, to apprise the public of the scope of the present invention, the following claims are made.

What is claimed is:

1. An image processing system comprising:
an image input apparatus;
an image processing apparatus; and
an image output apparatus,
the image input apparatus, the image processing apparatus and the image output apparatus being connected via a public network,
the image processing system charging a fee at the image processing apparatus when outputting data input from the image input apparatus using the image output apparatus,
image input apparatus generating image data for output based on information including digital contents, extracting electronic watermark data embedded as an electronic watermark in the digital contents and generating account information based on the electronic watermark data, and transmitting the image data and the account information to the image processing apparatus,
the image processing apparatus billing based on the account information in response to an output request from the image output apparatus and transmitting the image data to the image output apparatus,
the image output apparatus outputting the image data transmitted from the image processing apparatus.

2. The image processing system of claim 1, wherein the image output apparatus prints out the image data transmitted from the image processing apparatus.

3. The image processing system of claim 1, wherein the image input apparatus generates account information in response to predetermined discount information based on the electronic watermark data.

4. The image processing system of claim 3, wherein, where there is a plurality of electronic watermark data, the image input apparatus generates account information in response to discount information for each of the respective electronic watermark data.

5. The image processing system of claim 4, wherein the discount information shows a discount rate and, where there is a plurality of electronic watermark data, the account information is generated according to an aggregate discount rate obtained by adding together the individual discount rates.

6. The image processing system of claim 5, wherein an upper limit of the aggregate discount rate is limited to a predetermined value.

7. The image processing system of claim 3, wherein the electronic watermark data includes copyright information.

8. The image processing system of claim 3, wherein the electronic watermark data includes user information.

9. The image processing system of claim 3, wherein the image input apparatus transmits the image data and the account information to the image processing apparatus as a single job.

10. The image processing system of claim 9, wherein the image processing apparatus deletes the job when there is no output request from the image output apparatus within a predetermined period of time after the job is transmitted from the image input apparatus.

11. The image processing system of claim 10, wherein the predetermined period of time is retained as data in the job.

12. The image processing system of claim 9, wherein:
a plurality of image output apparatuses are connected; and
the image input apparatus adds data to the job that designates the image output apparatus for that job.

13. The image processing system of claim 1, wherein the image input apparatus is a personal computer.

14. An image processing system comprising:
an image input apparatus; and
an image output apparatus,
the image input apparatus and the image output apparatus being connected via a public network,
the image processing system charging a fee when outputting from the image output apparatus image data input from the image input apparatus,
the image input apparatus generating image data for output based on information including digital contents, extracting electronic watermark data embedded as an electronic watermark in the digital contents and generating account information based on the electronic watermark data, and transmitting the image data and the account information to the image processing apparatus,
the image processing apparatus billing based on the account information in response to an output request from the image output apparatus and outputting the image data.

15. In an image processing system in which an image input apparatus, an image processing apparatus and an image output apparatus are connected via a public network, an image processing method that generates account information when outputting from the image output apparatus image data input from the image input apparatus,
the image input apparatus generating image data for output based on information including digital contents, extracting electronic watermark data embedded as an electronic watermark in the digital contents and generating account information based on the electronic watermark data, and transmitting the image data and the account information to the image processing apparatus,
the image processing apparatus billing based on the account information in response to an output request from the image output apparatus and transmitting the image data to the image output apparatus,
the image output apparatus outputting the image data transmitted from the image processing apparatus.

16. In an image processing system in which an image input apparatus and an image output apparatus are connected via a public network, an image processing method that generates account information when outputting from the image output apparatus image data input from the image input apparatus,
the image input apparatus generating image data for output based on information including digital contents, extracting electronic watermark data embedded as an electronic watermark in the digital contents and generating account information based on the electronic watermark data, and transmitting the image data and the account information to the image processing apparatus,
the image processing apparatus billing based on the account information in response to an output request from the image output apparatus and outputting the image data.

17. A program that causes a computer to function as the image input apparatus of claim 1.

18. A program that causes a computer to function as the image processing apparatus of claim 1.

19. A computer-readable storage medium on which the program of claim 17 is stored.

20. A computer-readable storage medium on which the program of claim 18 is stored.
